(19) United States
(12) Patent Application Publication
(10) Pub. No.: US 2006/0059097 A1
(43) Pub. Date: Mar. 16, 2006

(54) Apparatus and method for automated management of digital media

(76) Inventor: David Langley Kent, Modesto, CA (US)

Correspondence Address: Cooley Godward LLP;ATTN: Patent Group, Five Palo Alto Square, 3000 El Camino Real, Palo Alto, CA, 94306-2155, US

(21) Appl. No.: 11/221,579

(22) Filed: Sep. 7, 2005

Related U.S. Application Data
(60) Provisional application No. 60/607,944, filed on Sep. 7, 2004.

(51) Int. Cl. G06Q 99/00

(52) U.S. Cl. 705/57

(57) ABSTRACT

The invention includes a method of using software to automate the acquisition, processing and syndication of digital media files, in particular, as it relates to this process, digital music files. This method can be extended to include all digital forms of intellectual property to which an individual, corporation, or other entity, owns or controls the digital exploitation rights (e.g., digital video, literature, designs). The invention creates a model of a digital media business and controls day-to-day operations with computer systems. Without this invention, digital media businesses intending to compete in the online marketplace would not have the ability to scale operations to the degree necessary to become viable because the large number of digital assets required for profitability would otherwise be unmanageable. 14.

### CROSS REFERENCE TO RELATED APPLICATIONS

This application claims the benefit of U.S. Provisional Application No. 60/607,944, entitled “Apparatus and Method for Automated Management of Digital Media” filed on Sep. 7, 2004, the disclosure of which is incorporated herein by reference in its entirety.

### BRIEF DESCRIPTION OF THE INVENTION

This invention relates generally to the distribution of digital media. More particularly, this invention relates to an automated technique for the acquisition, processing and syndication of digital media files.

### BACKGROUND OF THE INVENTION

Small companies attempting to leverage the supply of, and demand for, digitized intellectual property encounter barriers to scalability due to the inability to offload to automated systems the complex and interrelated processes necessary to acquire, inventory, process, track and syndicate digitized intellectual property. Scalability is essential because the intrinsic value of a single digitized item of intellectual property is small compared to the market value of exposing a vast number of digitized intellectual properties to consumers. This is a direct result of a consumer market driven by demand for selection. It is too difficult to predict which digitized intellectual property will be selected by the consumer; in fact, the chances of any single digitized intellectual property being selected is generally so small that the only practical solution for a viable digital media business is to have a large number of files available for purchase. Additionally, traditional optimizations to improve profitability, such as the identification of exceptional assets for selective marketing and promotion, have largely been ignored by digital media companies that have treated a large number of assets as homogenous in order to achieve scalability. Lastly, the intolerance of nonconformance, such as the disorderly introduction of metadata, by traditionally automated digital media businesses, restricts the volume of finished and available digital goods, thereby compromising scalability.

The prior art includes techniques for individual operations, such as the acquisition of metadata, bulk encoding of music files into multiple formats, and royalty monitoring systems. However, these functions have been performed in isolation. This results in a number of problems. First, there are inefficient transfers of data from one process to another. An isolated approach also introduces data bottlenecks. Improvements in one process may be nullified if associated processes are not altered, thereby precluding appropriate scaling. Scalability should occur in unison across all processes in order to maintain maximum productivity. Metrics required to optimize revenue are often interactive between processes. Therefore, an isolated approach makes it difficult to calculate the most accurate indication of asset quality and desirability.

In view of the foregoing, there is a need for integrated and automated management of digital media.

### SUMMARY OF THE INVENTION

The automation of a digital media business is performed by a system including a relational database containing the descriptions and normalized relationships of entities that represent the suppliers, consumers, managers and other digital media business participants, as well as the specific rights and privileges held by the entities regarding the ownership and/or control of digitized intellectual properties, and locations of the digitized intellectual properties themselves.

The system includes mass storage devices that contain the digitized intellectual properties, a human interface, accessible by the management staff of a digital media business, to view and invoke operations on the entity-participants and digitized intellectual properties, such as attaching metadata to music files, trans-coding audio formats for syndication, exporting metadata, importing revenue and activity statements, and generating disbursements.

The human interface of the system, which is accessible to the owners and/or controllers of digitized intellectual properties, allows one to view and invoke operations on a restricted set of entity-participants and digitized intellectual properties, such as uploading digital media files for review, altering contact information, specifying usage terms and restrictions, and viewing individual disbursement activity. Further, the system includes highly interoperable and highly available software that implements control processes, inventory, accounting and merchant services.

The invention ensures the viability of digital media businesses by automating the management of the acquisition, tracking, transformation, syndication and distribution of digitized intellectual properties to consumers with minimal manual intervention. By virtue of interoperability, operational customizations are achieved to accommodate a wide variety of consumer-ready formats. In addition, the system adapts to changing conditions and tailors its processing to optimize the value of individual digitized intellectual properties.

### BRIEF DESCRIPTION OF THE FIGURES

The invention is more fully appreciated in connection with the following detailed description taken in conjunction with the accompanying drawings, in which:

FIG. 1 illustrates a digitized intellectual property acquisition system implemented in accordance with an embodiment of the invention.

FIG. 2 illustrates a digitized intellectual property review and transformation system implemented in accordance with an embodiment of the invention.

FIG. 3 illustrates a digitized intellectual property syndication system implemented in accordance with an embodiment of the invention.

FIG. 4 illustrates a digitized intellectual property revenue disbursement and optimization system implemented in accordance with an embodiment of the invention.

Like reference numerals refer to corresponding parts throughout the several views of the drawings.

### DETAILED DESCRIPTION OF THE INVENTION

The invention's various components assume that a number of “best practices” are applied to the implementation. For example, it is assumed that the relational database is accessible to all other components and applies strict rules and constraints that guarantee data integrity.

Presuming a best practices implementation, the processes that evaluate, transform and deploy digital assets are specialized enough to operate over a variety of digital formats and still cooperate and interact seamlessly with the system. For example, each form of digitized intellectual property has a dedicated software program built to expose a common system interface through which it can be controlled. In the case of a digital audio file, an MPEG 3 encoder/decoder obtains information about assets to be encoded for a particular distribution medium through this interface and performs its encoding task unattended for many thousands of digitized intellectual properties.

The invention's ability to identify exceptional digitized intellectual properties and/or tolerate chaos and errors without manual intervention is assisted by several quality metrics established by analysis of the following exemplary issues:
a) The quality of the original digitized intellectual property form, such as a master recording. For audio material, this evaluation can be assisted by an analysis of the frequency spectrum and amplitude envelope, as well as statistical clues evident in the accompanying metadata.
b) The quality of the digital transformations, if any, to prepare the asset for distribution.

This evaluation can be assisted by the detection of waveform transients and other unusually randomized data within an audio or video stream.
c) The quality of accumulated and finalized metadata obtained by the fulfillment of internal business processes and/or correlation with external sources. For music, artist and repertoire, considerations are applied during the review process and the quality of such descriptions and judgments can be weighed by measuring the completeness, consistency and authorship of the data. In addition, audience awareness of musical compositions and artists can be gauged by querying web sites and publicly accessible databases. The quality of such information may be ascertained by similar methods.
d) The quality and accuracy of legal rights and privileges held by all parties with an interest in a particular digital asset. For audio material, this would include an automated analysis of contracts, explicit or implied, pertaining to composers, writers, performance rights organizations, publishers and the like.
e) The quality of the intended retail outlet with respect to consumer experience and asset delivery timing.

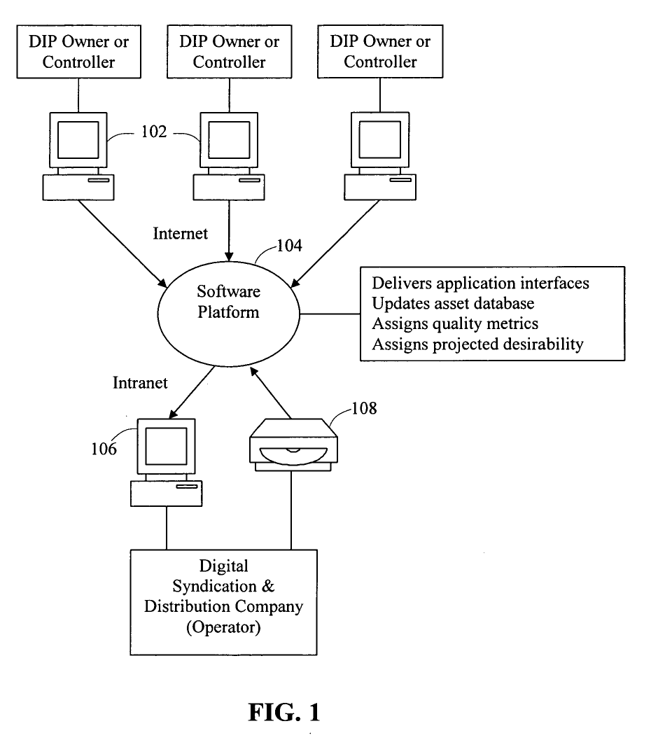

As shown in FIG. 1, the process is initiated by the digitized intellectual property owner and transpires in the following manner:
Step 1. IP owner or controller seeks to monetize digitized intellectual property (“DIP”). The IP owner may be viewed as a client computer 102 in a networked environment (e.g., the Internet).
Step 2. Access web-based software platform through user interface. The web-based software platform may be a server 104 forming a portion of an intranet with a control computer 106 and a read/write memory facility 108.
Step 3. Enter in relevant detailed description/characteristics and rules governing DIP. In particular, a user of a client computer 102 inputs this information. This information may be entered using downloaded software from the software platform 104.
Step 4. Customize format of DIP—the way it will be exhibited before digital purchasers. This may be facilitated using downloaded software from the software platform 104.
Step 5. Save information and send to the remote software platform. Again, using the downloaded software from the software platform 104, the information is routed over a network to the software platform 104.
Step 6. Upload digital copy of IP to software platform. The digital copy of the IP is typically resident on a client computer 102, but my come from any source.
Step 7. Where applicable, send physical copy to designated operator.

Thus, FIG. 1 illustrates the acquisition of digitized intellectual property in accordance with an embodiment of the invention. As indicated above, the software platform 104 may be configured to deliver application interfaces to the clients 102. The software platform 104 is also preferably configured to update an asset database, assign quality metrics, and assign a projected desirability value.

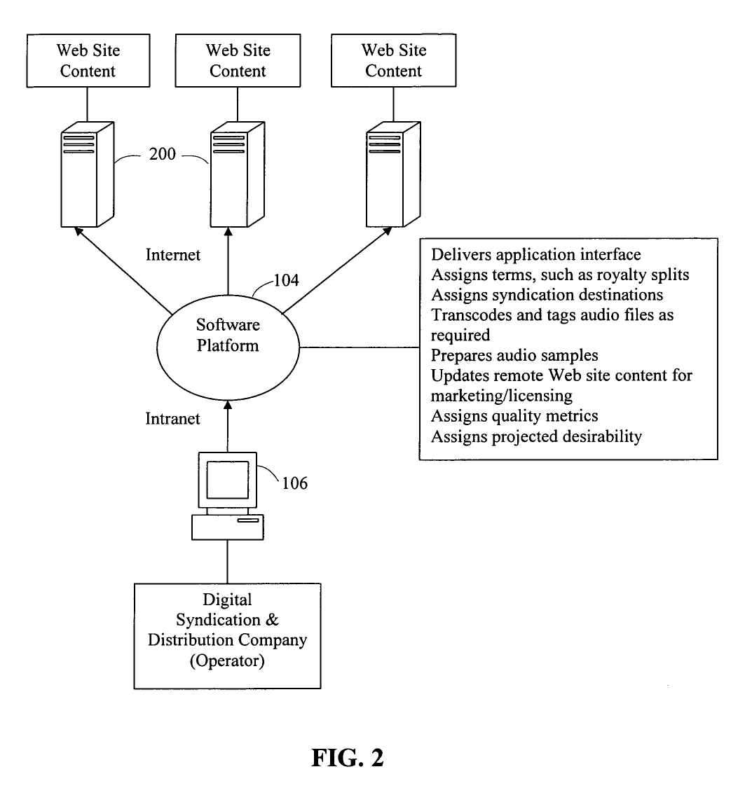

The software platform 104 fully prepares all digitized intellectual properties for sale by applying a wide variety of transformations according to a prescribed schedule, as illustrated in connection with FIG. 2. For example:
audio file is reviewed, catalogued and analyzed for initial quality and desirability metrics
a digital sample file is prepared automatically based on an algorithm to determine the most representative contiguous segment of the asset
relevant metadata is collected (e.g. artist information, associated artwork, licensing terms)
consumer destinations are assigned
a configuration matrix is established based on the above factors
the matrix is then applied to produce the required formatting for all the digitized intellectual properties' components (e.g., artist images, metadata, audio file type)
audio components are automatically transcoded
encryption and/or digital rights management are applied, as required
components are sent to a designated staging area for syndication

As business processes are applied to move digitized intellectual properties from acquisition to distribution, the quality metrics are combined with formulas to obtain an overall characterization of each asset. A minimal set of master thresholds are then set in order to determine which digitized intellectual properties are allowed to be released as finished goods. In this way, a quality standard is maintained and enforced with minimal effort, thereby contributing to the desired scalability for an automated business. Those assets that are below the established quality threshold are archived and reviewed for potential exclusion from future exploitation.

FIG. 2 illustrates the software platform 104 operative with the control computer 106. The software platform may interact with content servers 200 to perform functions, such as assign terms, such as royalty splits, assign syndication destinations, transcode and tag audio files, prepare audio samples, update remote content, assign quality metrics, and assign projected desirability based upon information processed during the review and transformation process.

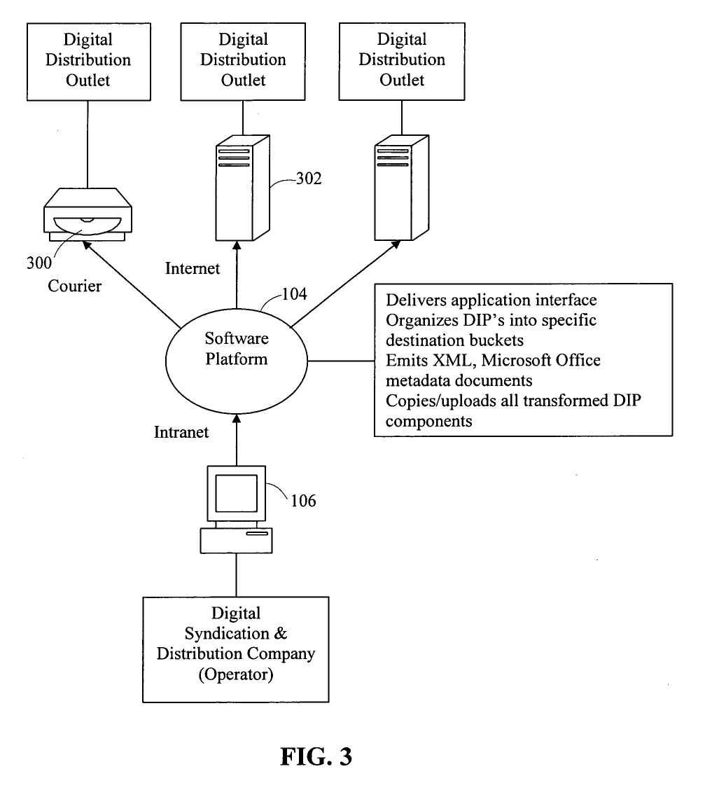

The next step in the process is to syndicate, or directly distribute, the digitized intellectual properties. The invention utilizes software to aggregate individual digitized intellectual properties from the staging area based on their desirability, quality and consumer destinations. All related DIP components are prepared for syndication in the following manner as shown in connection with FIG. 3:
Step 1. Review information and copy of DIP.
Step 2. Assign and/or confirm additional characteristics and syndication/distribution rules where necessary.
Step 3. Perform any additional tasks necessary to prepare DIP for digital sale to consumers, such as preparation of sample clips of audio files.
Step 4. Encode DIP in multiple formats through automated process.
Step 5. Validate that DIP is ready for syndication to online distribution services/storefronts.
Step 6. Organize DIPs into categories, or other units, as requested by the various digital distribution outlets that will be selling DIPs to consumers.

Once a quorum of digitized intellectual properties within the staging area is available, as predetermined by management and/or previously analyzed metrics, the assets are copied to the relevant distribution export devices, including, but not limited to:

hard drives

digital video discs

file transfer protocol

compact discs

digital linear tapes

The DIPs are then delivered to digital distribution outlets/storefronts in the following manner as shown in connection with FIG. 3:
Step 1. Store copies of DIPs and accompanying metadata onto physical media, such as DVD or hard drive, to send to the outlets or upload DIPs over an Internet connection to a designated FTP or similar site. FIG. 3 illustrates the delivery of a disk 300 and the uploading of DIPs via computer 302.
Step 2. Ensure that digital distribution outlets receive DIPs and validate the information and quality of the DIPs.
Step 3. Emit XML, Microsoft Office, text, Adobe and metadata documents.

In sum, FIG. 3 illustrates that the software platform 104 performs one or more of the following functions: organizes DIPs into specific destination buckets, generates XML and metadata documents, and copies transformed DIP components.

Once the digitized intellectual properties are determined to be available to consumers through digital (online and mobile) distribution outlets, their activity and performance are monitored to produce final quality and desirability metrics plus revenue and sales analyses. The invention produces these results through several methods, including:
importing sales and activity reports provided by the digital distribution outlets and collecting statistics on the performance of specific DIPs
impersonating consumers of goods and services provided by the digital distribution outlets and analyzing their experience
scraping publicly available web pages and/or public documents that describe the general awareness and popularity of the digitized intellectual properties

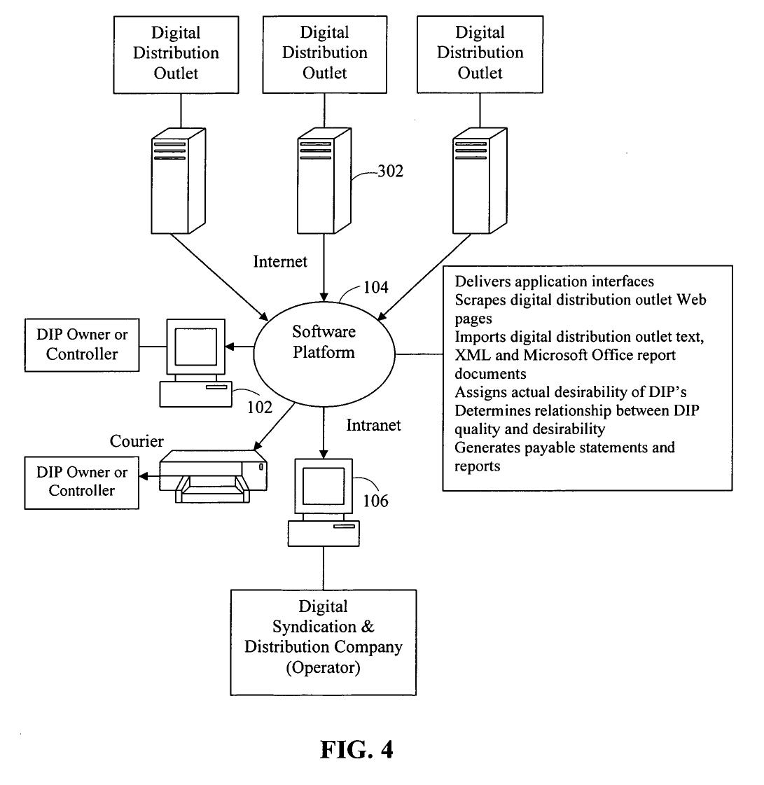

In order to optimize the profitability of the business without manual intervention, a feedback loop is established between a revenue analysis and characterization of each digitized intellectual property. The desirability metric is established for each asset based on some attribute or trend that is determined to predict its ability to contribute revenue to the system. Such assets are favored, rising to the forefront for priority processing, promotion, reporting and trend analysis. Sales, royalty and performance ingestion from digital distribution outlets produce disbursement of funds. This can be more fully appreciated in connection with FIG. 4 and the following exemplary operations:
Step 1. Track which digital distribution outlets received DIPs.
Step 2. Alert DIP owner or controller—either though the web-based interface or other communication method—that their DIP is available for sale through designated digital distribution outlets.
Step 3. Online outlets send electronic or physical copies of sales performance.
Step 4. Operator ingests DIP performance reports into Software Platform 104.
Step 5. Software Platform 104 aggregates performance metrics and payment totals where appropriate.
Step 5. DIP owner or controller views totals through their human online interface.
Step 6. Operator processes payment to DIP owner or controller as needed.

The interaction between desirability and quality can be exploited to give the system an adaptive nature, using any of a number of widely available methods in the public domain to discover and introduce optimizations to formulas and processes automatically over time. For example, a formulaic or genetic analysis can utilize the metrics most recently received to adjust the algorithms that assign the initial metrics to incoming digitized intellectual properties.

Once the sales and activity reports from digital distribution outlets are converted from their respective formats to a uniform performance report, the aggregation of the sales activity is combined with royalty splits and other individualized terms to determine the payout to each digitized intellectual property owner. The invention is able to calculate the appropriate amounts in a fully automated manner and issue payable reports summarizing the overall disbursement of revenue.

Embodiments of the invention include various additional and alternative techniques. For example, an initial ranking of DIP may be based upon the historical performance of the owner, as derived from previous rankings. The initial ranking may set an expected desirability metric and guide the initial distribution process to consumers and prioritization of processing resources.

Ideally, a large amount of data is gathered from the outset of the DIP management process. This data can be reduced, modified or stored for later use as the ongoing DIP management process unfolds. Any characteristic of DIP determined to have influence over desirability, quality and/or uniqueness is considered for archival purposes. In some embodiments of the invention, each quality characteristic is evaluated when DIP is received and a combined total and probabilistic calculation is derived. For example, the ability to pay accurately on DIP sales (and thus use sales to determine quality and desirability) is driven by the platform's ability to receive accurate sales data from a distribution outlet. In one instance, the platform uses a fuzzy logic based technique call “fuzzy matching” that uses an automated function to match the true DIP characteristics to the ones provided by the owner. Fuzzy matching allows for some human error, but ranks the likelihood of an accurate match, and factors that into the overall assessment of the quality of the DIP and the associated performance data.

Preferably, during each step along DIP processing and evaluation, metrics are gathered and the DIP's summary characteristics and desirability matrix are continually updated. Summarized DIP characteristics can be adjusted and moved into different buckets or classifications in order to improve desirability and performance. The quality of specific DIP data can be monitored to help set initial and ongoing prioritization. For example, how many metadata errors were found when DIP was initially brought in? Missing information and excessive time taken to catalogue the digital asset results in relative de-prioritization because it can be anticipated that the expected value of the DIP is low. Overall robustness of metadata helps enhance the value of a DIP, as it helps target its desirability segment.

Metrics are updated and an owner is assigned a generally higher ranking based on the positive combined assessment of all metrics gathered during processing plus continued good performance of the owner's DIP. Most recent performance is weighted more heavily than decaying older performance metrics. As performance is calculated, investment in a specific DIP, in terms of processing, human and capital resources can fluctuate based on return on investment. The invention can utilize scaling, such that at every step in the process where the system is required to utilize resources, all the resources submitted to that process are prioritized, and depending on the arbitrary conditions that are set, only the top performing assets are pushed through the process. The remaining assets can be delayed, thus maximizing use of resources and return on investment.

Process input and output may be governed by any number of graphical user interfaces. For example, an executive dashboard may be used that displays current conditions and enables executive responses that can influence the strategy of a business. This is accomplished by several controls that are available via a simple interface that clearly sets overall quality and desirability goals, thereby adjusting the balance between the number of assets permitted to be finished and the amount of resources to be expended.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A method of automated management of digital media, comprising:
preparing digitized intellectual property for sale; and
producing quality and desirability metrics for said digitized intellectual property.

2. The method of claim 1 further comprising delivering said digitized intellectual property for syndication to consumers.

3. The method of claim 1 further comprising delivering said digitized intellectual property for direct distribution to consumers.

4. The method of claim 1 further comprising monitoring activity and consumption of said digitized intellectual property.

5. The method of claim 4 further comprising automatically adapting said preparing and producing operations in response to said monitoring.

6. The method of claim 1 further comprising collecting and disbursing revenue to multiple payees in accordance with individualized terms.

7. A computer readable medium, comprising executable instructions to:
prepare digitized intellectual property for sale; and
produce quality and desirability metrics for said digitized intellectual property.

8. The computer readable medium of claim 7 further comprising executable instructions to deliver said digitized intellectual property for syndication to consumers.

9. The computer readable medium of claim 7 further comprising executable instructions to deliver said digitized intellectual property for direct distribution to consumers.

10. The computer readable medium of claim 7 further comprising executable instructions to monitor activity and consumption of said digitized intellectual property.

11. The computer readable medium of claim 7 further comprising executable instructions to collect and disburse revenue to multiple payees in accordance with individualized terms.
